(19) United States
(12) Patent Application Publication
(10) Pub. No.: US 2013/0077748 A1
(43) Pub. Date: Mar. 28, 2013

(54) X-RAY APPARATUS

(71) Applicants: Felix Althoff, Erlangen (DE); Joerg Freudenberger, Kalchreuth (DE); Martin Hupfer, Lauf (DE); Harry Schilling, Schwabach (DE)

(72) Inventors: Felix Althoff, Erlangen (DE); Joerg Freudenberger, Kalchreuth (DE); Martin Hupfer, Lauf (DE); Harry Schilling, Schwabach (DE)

(21) Appl. No.: 13/627,657

(22) Filed: Sep. 26, 2012

(30) Foreign Application Priority Data
Sep. 26, 2011 (DE) DE 102011083416.8

(51) Int. Cl. G01T 7/00; G01N 23/04

(52) U.S. Cl. 378/62; 378/207

(57) ABSTRACT

An X-ray apparatus includes an X-ray source and a detector operating in conjunction with the X-ray source. The X-ray apparatus also includes a correction object having a defined geometry and/or known radiation absorption behavior disposed between the X-ray source and the detector. The correction object is detectable by the detector and configured to indicate characteristics of the X-ray source such as a focal spot position.

This application claims the benefit of DE 10 2011 083 416.8, filed on Sep. 26, 2011.

### BACKGROUND

The present embodiments relate to an X-ray apparatus and to a method for operating such an X-ray apparatus.

In an X-ray tube, X-ray radiation is produced by the incidence of an electron beam on an anode. In the case of a fixed anode, the incident electrons define a focal spot. in the case of a rotating anode, a focal path is produced during operation of the X-ray tube.

DE 103 01 071 A1 discloses a device and a method for adjusting the focal spot position of an X-ray tube. The focal spot position is to be adjusted not by open-loop control, but by closed-loop control in order to automatically compensate both predictable and non-predictable interference affecting the adjustment of the focal spot position. Sensors are provided to measure a signal indicative of the focal spot position. This signal is used as the controlled variable for closed-loop deflection control. The focal spot position may be measured, for example, by locally resolved determination of the intensity of the X-ray beam or by measuring the temperature at the anode (e.g., using infrared cameras).

JP 11009584 A discloses a method for tracking the position of an X-ray beam. The method is configured to maintain the position of the X-ray beam even in the event of temperature-induced displacement of the focal spot. The X-ray beam is incident through an adjustable, slot-shaped diaphragm on a detector including a photodiode array and providing locally resolved intensity measurement in two dimensions.

DE 196 50 528 A1 relates to a method and apparatuses for determining an X-ray beam position in multiple-slice computed tomography scanners. In this case also, detection device cells disposed in separate rows are provided for determining the focal point position of the X-ray radiation. The signals supplied by the detection device cells are used to control a collimation device tracking mechanism.

WO 2008/132635 A2 discloses a medical imaging system having an X-ray source. It is assumed that the position of a focal point in a longitudinal direction is a function of the temperature of at least one X-ray component. Based on this relationship, a collimator position is varied as a function of temperature in a computer-assisted manner.

### SUMMARY AND DESCRIPTION

The present embodiments may obviate one or more of the drawbacks or limitations in the related art. For example, an X-ray apparatus having low equipment complexity compared to the cited prior art (e.g., with respect to the geometric quality of the imaging characteristics) is provided.

The embodiments and advantages explained in the following in connection with the X-ray source also apply analogously to the method, and vice versa.

The X-ray apparatus includes an X-ray source and a detector operating in conjunction with the X-ray source. The X-ray apparatus also includes a correction object disposed between the X-ray source and the detector and having a defined geometry and/or known radiation absorption behavior. The correction object is detectable by the detector. The correction object is configured to indicate characteristics of the X-ray source (e.g., a focal spot position of the X-ray source) on the detector.

The position of the X-ray radiation source in an X-ray tube (e.g., the focal spot position) changes during operation due to the thermally induced expansion of the X-ray tube components. In an X-ray tube with rotating anode, as disclosed, for example, in DE 103 01 071 A1 and priority U.S. Pat. No. 7,001,071 B2, the rotating anode itself, a connecting element between the rotating anode and a bearing, the bearing or individual parts of the bearing, a vacuum housing or some other part of the X-ray tube may expand. The various parts may be subject to different degrees of thermal expansion.

Such a change in the geometry of the X-ray source occurring during operation of an X-ray apparatus provides a displacement of the X-ray source relative to the detector and therefore a displacement and/or distortion of an image captured by the detector. This is disadvantageous in cases in which a series of connected images is captured, as in computed tomography. The change in the imaging geometry distorts local relations between object features that are reproduced on different images. Another disadvantageous effect of thermally induced dimensional variations in an X-ray source is a loss of resolution if the thermally induced movement is large compared to the pixel size of the detector.

In contrast to the methods proposed in the prior art, which involve intervening at the X-ray source in order to preserve imaging quality as far as possible in the event of thermally induced geometric changes, in one embodiment, data acquired by the detector is used to compensate a change in the focal spot position due to thermal, mechanical or other causes. According to an advantageous embodiment of the method, no intervention in the imaging characteristics of the X-ray apparatus (e.g., by adjusting a collimator) is involved.

Accordingly, the X-ray apparatus is implemented and provided with an image evaluating unit such that a change in the focal spot characteristics (e.g., a displacement or a change of cross section) is detected. For this purpose, for example, a comparison of the data acquired during a scan with stored (nominal) data or even with data of a previous scan is provided. The X-ray apparatus is additionally configured such that any such change in the focal spot characteristics is compensated solely via a mathematical correction algorithm on the basis of the data obtained during the scan. This also applies, for example, to a series of image recordings during an examination of an object being examined. During the entire series, compensation is performed solely via the image evaluating unit and purely mathematically, without hardware intervention in the beam path.

The method includes monitoring of the focal spot geometry (e.g., the focal spot position). This is performed in a particularly simple manner in terms of equipment complexity by inserting a correction object having a defined geometry and known radiation absorption behavior in an irradiated area between the X-ray source and an associated detector. The correction object produces a unique signature in the data acquired by the detector at each stage of data processing, thereby indicating characteristics of the X-ray source (e.g., the focal spot position). The characteristics of the X-ray source or the focal spot geometry include, for example, the position of the focal spot and the shape, size and profile as the geometric variables thereof. At least one of these characteristics is recorded by the detector and evaluated automatically or in a computer-assisted manner.

The temperature- or mechanically induced change in the focal spot geometry may be compensated at the earliest possible stage of processing of the data acquired by the detector. In the case of a computed tomography system such as that disclosed, for example, in WO 2008/132635 A2, even raw data, for example, that is provided for generating evaluatable image data is corrected directly with respect to compensating the change in the focal spot geometry, thereby minimizing loss of resolution. The changes in the focal spot geometry may likewise also be compensated during the reconstruction of images from the unchanged raw data. In the following, therefore, both the correction of the raw data and the corresponding reconstruction of the image data are included under “correction of raw data”.

During an X-ray examination, a plurality of images may be taken in immediate succession as a series. In one embodiment of the method, the compensation proposed is also performed for such a series solely via the described mathematical compensation within the raw or image data, without hardware intervention. Therefore, even comparatively large changes to the focal spot geometry during an X-ray examination are performed exclusively by mathematical compensation.

In one embodiment of the X-ray apparatus, the incorporated correction object has a non-zero transmittance with reference to the X-ray radiation emitted by the X-ray source (e.g., the correction object is at least partially permeable to X-ray radiation).

The permeability may be calculated such that the correction object may also be disposed within the radiation field that also irradiates the object under examination, and the data for examining the object under examination may also be evaluated in this region shadowed by the correction object. Attenuation values for the object under examination and for the correction object therefore overlap. By subtracting the known attenuation values for the correction object, the attenuation values of the object under examination that are to be used for image reconstruction may therefore be determined.

In one embodiment, the transmittance of the correction object may range from 20 to 80% (e.g., 20 to 80% of the intensity incident on the correction object passes through the correction object). Depending on the variant, the transmittance is optionally between 20 and 50% or between 50 and 80%.

The correction object may be disposed completely within, partly within or completely outside the cross section of the object to be examined by X-ray radiation and therefore correspondingly relative to an image captured by the detector. Placing the correction object in the same radiation cross section as the radiation cross section in which the object under examination is also disposed has the advantage that no part of the radiation cross section is to be reserved for correction purposes and is therefore unavailable for actual X-ray examination. Positioning the correction object outside the radiation cross section used for the examination has the advantage that the formation of artifacts in the image data is inherently eliminated.

According to one embodiment, the detectability of the correction object in the case of the partially X-ray permeable implementation is improved by the correction object having a plurality of regions exhibiting different radiation absorption behavior. The regions that differ from one another with respect to transmittance may be produced by different wall thicknesses of a single material and/or by using materials having different transmission coefficients. Each of these regions is semitransparent (e.g., having a transmittance ranging from 20 to 80%).

The different levels of transmittance of the different regions are, for example, in the 20%, 50% and 80% range.

In each case, particularly if the correction object is completely embedded in the image acquired by the detector, the effects of a changed geometry of the X-ray apparatus on the imaging may be unambiguously inferred from the defined signature (e.g., comparable to a watermark) produced by the correction object. Any such effect may be subtracted from the image data or from raw data present as a precursor of image data in terms of reconstruction. The “watermark” virtually underlies the actual image or absorption data of the object under examination.

According to an embodiment of the X-ray apparatus, the correction object is at least almost impermeable to the X-ray radiation emitted by the X-ray source. The correction object may be outside or at the edge of the cross section examined by the X-ray radiation. In one embodiment, the correction object is formed by contours of a diaphragm that delimit an image captured by the detector and are detectable by the detector. This reliably prevents structures of the correction object from appearing within the object under examination and possibly making image data evaluation more difficult. The detector covers a larger cross section than the diaphragm-delimited cross section defining the examination area.

Irrespective of whether the correction object is disposed inside or outside the cross section under examination, the correction object, viewed from the X-ray source, may be positioned either in front of or behind an object under examination disposed in the examination volume. In all cases, the X-ray source, the detector and the object under examination (e.g., an imaging object) may be moved relative to one another. Depending on the positioning of the correction object, the correction object is attached, for example, to the detector, to a beam diaphragm, to the object under examination or imaging object or to the X-ray source.

An advantage of the present embodiments is, for example, without intervening in the hardware of an X-ray apparatus, any drift of the focal spot from the original position is compensated solely by correcting the data acquired by the detector. All the data used for the correction is also acquired by the detector, without using an additional sensor, by evaluating the position and/or shape of, for example, a semipermeable correction object disposed in the beam path of the X-ray radiation and captured by the detector.

### BRIEF DESCRIPTION OF THE DRAWINGS

FIG. 1 shows a perspective view of one embodiment of an X-ray apparatus with correction object;

FIG. 2 shows an exemplary locally resolved detector signal of the X-ray apparatus according to FIG. 1, showing the signature of the correction object;

FIG. 3 shows an alternative form of a correction object;

FIG. 4 shows an exemplary signature of the correction object according to FIG. 3;

FIG. 5 shows another embodiment of an X-ray apparatus in a representation analogous to FIG. 1; and

FIG. 6 shows an exemplary locally resolved detector signal in a diagram analogous to FIG. 2 and FIG. 4.

### DETAILED DESCRIPTION OF THE DRAWINGS

Parts that are equivalent or produce the same effect are denoted by the same reference characters in all the figures.

An X-ray apparatus 1 (for basic operation, reference is made to the prior art cited in the introduction) has an X-ray source 2 and a detector 3 operating in conjunction with each other. The X-ray apparatus 1 is implemented, for example, as a computed tomography scanner. X-ray radiation emitted by the X-ray source 2 emanates from a focal spot 4 on, for example, a rotating anode (not shown in greater detail) of the X-ray source 2. In one embodiment, the X-ray source 2 is an X-ray radiator that has finite dimensions, in contrast to the representation of the X-ray source 2 in the drawings as a point source.

Located near the focal spot 4 in the radiation field of the X-ray radiation between the X-ray source 2 and the detector 3 is a mounting surface 5 that is disposed, for example, on a diaphragm in a collimator or on a separate surface that is fixed relative to the detector 3.

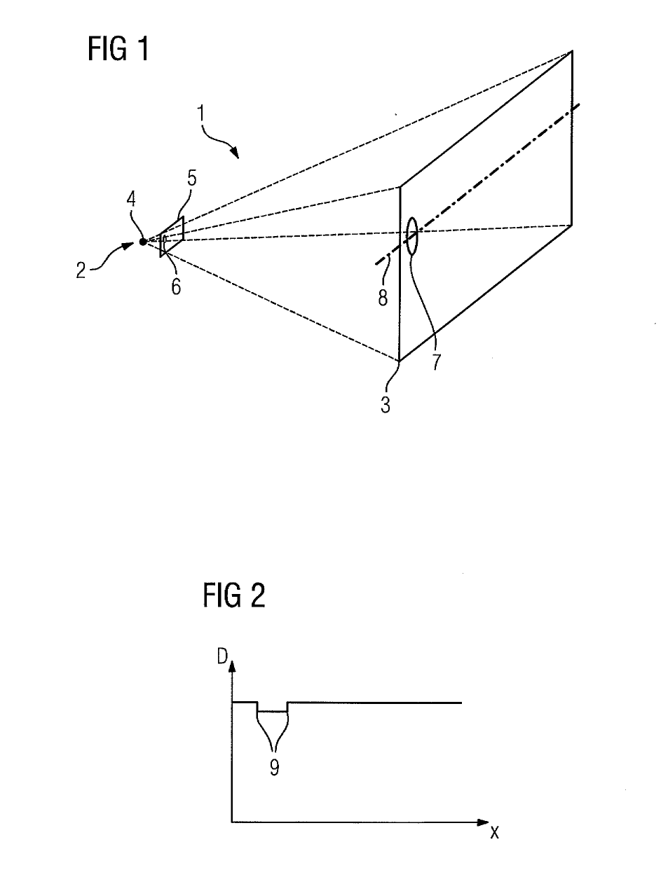

Attached to the mounting surface 5 is a correction object 6 that, in the exemplary embodiment according to FIG. 1, is a semitransparent structure (e.g., a cylinder made of polyether ether ketone (PEEK). The correction object 6 is reproduced on the detector 3 and may be seen in FIG. 1 as a correction image 7.

A line of intersection 8 that is set by the image acquired by the detector 3 intersects the correction image 7, reproducing the correction object 6. If the position of the focal spot 4 within the X-ray source 2 changes (e.g., due to temperature), the position of the correction image 7 acquired by the detector 3 is to be displaced.

The distribution of the X-ray radiation intensity detected by the detector 3 and therefore also the detected dose D along the line of intersection 8 is shown in FIG. 2. As in FIG. 1, for the sake of simplicity, a situation is considered in which there is no object under examination between the X-ray source 2 and the detector 3. Clearly visible is a lowering of the dose D in the region of the correction image 7. The lowered region is demarcated by edges 9 that reproduce the contour of the correction object 6.

If changes in the focal spot geometry occurring during operation of the X-ray apparatus 1 cause the positions of the edges 9 to be displaced, raw data acquired by the detector 3 or the image data obtained therefrom is corrected so that the raw data or the image data corresponds to data that would have been acquired if the focal spot geometry had remained unchanged (e.g., congruent edges 9 are always present on different images captured by the detector 3). The focal spot geometry is therefore corrected solely using data processing methods, without intervening in the operation of the X-ray source 2. In addition to the compensation of the changed geometry of the focal spot 4, the correction image 7 is automatically subtracted from the raw data containing the correction image 7 (e.g., even from the raw data present as precursor data), so that the correction object 6 is not visible to the user of the X-ray apparatus 1 on the images obtained.

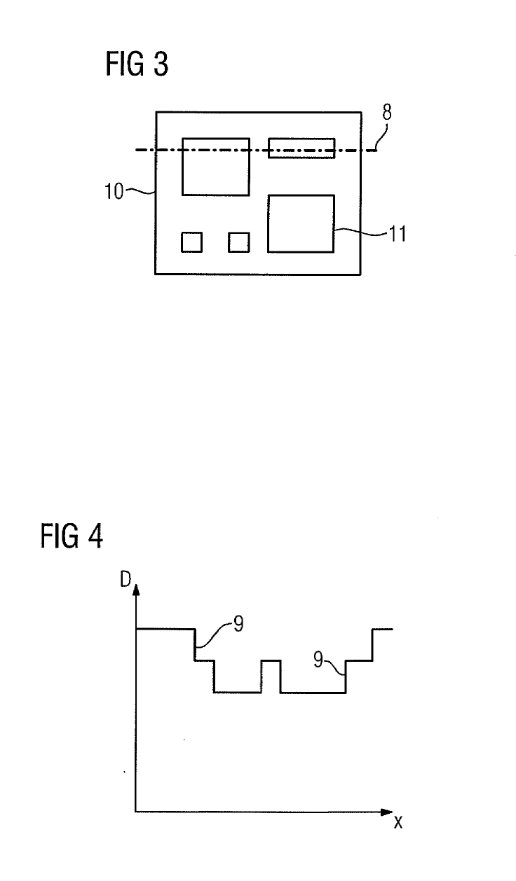

FIG. 3 shows a modified correction object 10 as compared to the exemplary embodiment shown in FIG 1. This has a plurality of surface regions 11 shown as rectangles in FIG. 2, in which the transmittance, with reference to the radiation emitted by the X-ray source 2, is selectively reduced compared to the other regions of the correction object 10. This is implemented, for example, by an increased thickness or by additionally applied layers of material.

Similarly, according to a variant of this exemplary embodiment, the absorption of X-ray radiation may also be reduced in the surface regions 11 compared to the surrounding regions of the correction object 10. For example, the surface regions 11 may be cutouts within the correction object 6.

If instead of the correction object 6 shown in FIG. 1 the correction object 10 according to FIG. 3 is used in the X-ray apparatus 1, the relationship shown in FIG. 4 between location x and dose D is produced along the dash-dotted line of intersection 8 marked in FIG. 3. Also in this case, a plurality of edges 9 that reflect the geometrically and radiationally defined characteristics of the correction object 10 may be seen. In the image captured by the detector 3, the correction object 10 is clearly defined, thereby allowing precise mathematical compensation of any change in parameters of the focal spot of the X-ray source 2.

The exemplary embodiment according to FIG. 5 differs from the exemplary embodiment shown in FIG. 1 in that the correction object 6 is constituted by the edges of a beam diaphragm 12. The complete outlines of the beam diaphragm 6 that are identical with the correction object 6 represent the correction image 7 captured by the detector 3. In order to represent the beam diaphragm 12 completely on the detector 3, the detector dimensions are increased compared to the exemplary embodiment shown in FIG. 1. Alternatively, by reducing the collimator size, the beam diaphragm 12 may be used as the correction object 6. In both cases, the correction object 6 is not located within a cross section examined by the X-ray apparatus 1.

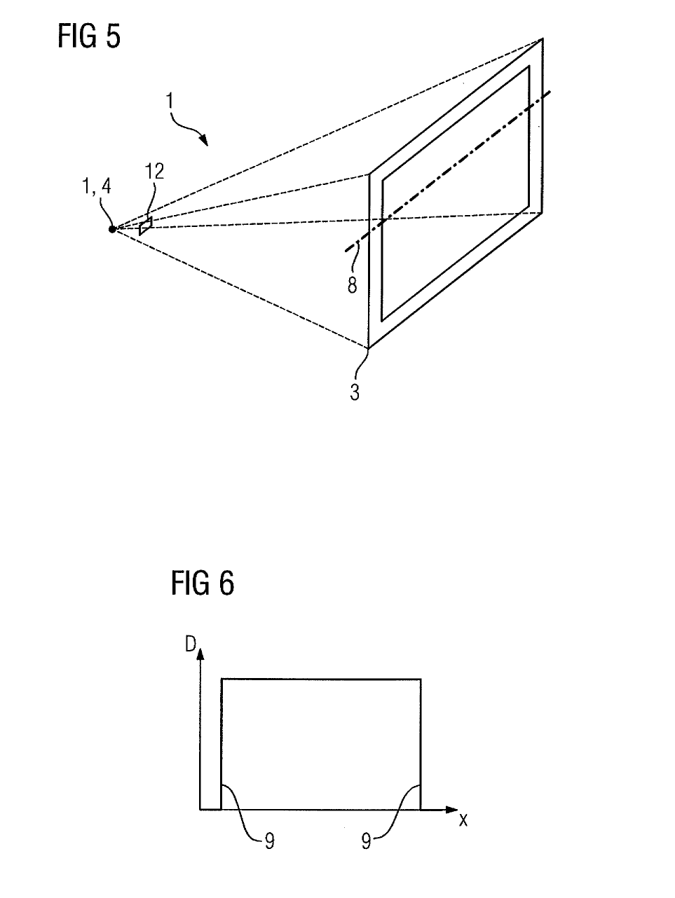

In the exemplary embodiment according to FIG. 5, the compensation of any change in the focal spot 4 takes place in the same way as in the exemplary embodiment according to FIG. 1. The dose distribution associated with the exemplary embodiment according to FIG. 5 along the line of intersection 8 is shown in FIG. 6. The edges 9 in this case include the borders of the image acquirable by the detector 3.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An X-ray apparatus comprising:
an X-ray source and a detector operating in conjunction with the X-ray source; and
a correction object having a defined geometry, a known radiation absorption behavior, or the defined geometry and the known radiation absorption behavior, the correction object being disposed between the X-ray source and the detector,
wherein the correction object is detectable by the detector and is configured to indicate characteristics of the X-ray source.

2. The X-ray apparatus as claimed in claim 1, wherein the correction object has a transmittance greater than zero referred to an X-ray radiation emitted by the X-ray source such that when the correction object is positioned between the X-ray source and an object under examination, a region of the object under examination shadowed by the correction object continues to be usable for image evaluation.

3. The X-ray apparatus as claimed in claim 2, wherein the transmittance ranges from 20% to 80%.

4. The X-ray apparatus as claimed in claim 2, wherein the correction object lies completely within an image of the object under examination captured by the detector.

5. The X-ray apparatus as claimed in claim 2, wherein the correction object is at least almost impermeable to X-ray radiation emitted by the X-ray source.

6. The X-ray apparatus as claimed in claim 5, wherein the correction object comprises contours of a beam diaphragm that delimit an image captured by the detector and are detectable by the detector.

7. The X-ray apparatus as claimed in claim 1, wherein the correction object includes a plurality of regions having different radiation absorption behavior from the radiation absorption behavior of surrounding regions.

8. The X-ray apparatus as claimed in claim 7, wherein each region of the plurality of regions is semitransparent to X-ray radiation, having different transmittances in the range 20-80%.

9. The X-ray apparatus as claimed in claim 1, wherein the detector is movable relative to the X-ray source.

10. The X-ray apparatus as claimed in claim 1, wherein the correction object is fixedly disposed relative to the X-ray source.

11. The X-ray apparatus as claimed in claim 1, wherein the correction object is fixedly disposed relative to the beam diaphragm, the detector, the object under examination, or a combination thereof.

12. A method for operating an X-ray apparatus, the method comprising:
generating X-ray radiation using an X-ray source that has an anode, on which a focal spot is formed by incident electrons;
determining a position of the focal spot;
detecting, using a detector, X-ray radiation generated by the X-ray source and irradiating an object under examination;
correcting or further processing data acquired by the detector as a function of at least one geometric variable of the focal spot such that a change in the at least one geometric variable is compensated.

13. The method of claim 12, wherein the at least one geometric variable comprises a focal spot position.

14. The method as claimed in claim 12, wherein the at least one geometric variable is compensated solely by correcting the data acquired by the detector, without intervention in imaging characteristics of the X-ray apparatus.

15. The method as claimed in claim 14, further comprising:
taking a series of shots of the object under examination;
compensating for the at least one geometric variable for each shot of the series of shots solely by correcting the data acquired by the detector without intervention in the imaging characteristics of the X-ray apparatus.

16. The method as claimed in claim 12, wherein compensating for the at least one geometric variable comprises correcting raw data acquired by the detector and used to produce image data.

17. The method as claimed in claim 12, further comprising determining the at least one geometric variable of the focal spot, the determining comprising inserting a correction object having known radiation absorption behavior in an X-ray irradiated region between the X-ray source and the object under examination.

18. The method as claimed in claim 12, further comprising determining the at least one geometric variable of the focal spot, the determining comprising inserting a correction object having defined geometry and known radiation absorption behavior in an X-ray irradiated region between the X-ray source and the detector.

19. The method as claimed in claim 17, wherein the correction object is semitransparent to X-ray radiation emitted by the X-ray source and is disposed inside a beam cross section irradiating the object under examination.

20. The method as claimed in claim 17, wherein the correction object is disposed outside a beam cross section irradiating the object under examination.
